(19) United States
(12) Patent Application Publication
(10) Pub. No.: US 2025/0367893 A1
(43) Pub. Date: Dec. 4, 2025

(54) WATER ANNEALING SYSTEM AND METHOD

(71) Applicant: The Prestwick Group, Inc., Sussex, WI (US)

(72) Inventors: Michael Kahn, Sussex, WI (US); Patrick Bersch, Sussex, WI (US)

(21) Appl. No.: 19/224,292

(22) Filed: May 30, 2025

Related U.S. Application Data
(60) Provisional application No. 63/654,288, filed on May 31, 2024.

(51) Int. Cl. B29C 71/02

(52) U.S. Cl. CPC B29C 71/02; B29C 2071/022

(57) ABSTRACT

An annealing system is provided in the form of a fixture, a tank, a heating element, and a hoist system. The fixture is designed to receive a plastic material and includes a frame having an open end. The tank is designed to receive the fixture and retain water and is provided in the form of a base coupled to sidewalls extending upwardly and away from the base. The heating element is coupled to and disposed within the tank and is designed to impart the water within the tank with a first temperature. The hoist system is designed to transport the fixture into and out of the tank. In addition, the annealing system is designed to anneal the plastic material.

### CROSS-REFERENCE TO RELATED APPLICATIONS

This application claims priority to U.S. Provisional Patent Application Ser. No. 63/654,288, filed on May 31, 2024, entitled “WATER ANNEALING SYSTEM AND METHOD,” currently pending, the entire disclosure of which is incorporated herein by reference.

### FIELD OF DISCLOSURE

The present disclosure relates to systems and methods for annealing plastic structures. More particularly, the present disclosure relates to systems and methods for annealing plastic structures in a water bath to help alleviate warping of the plastic structures during manufacturing.

### BACKGROUND

Current annealing techniques such as air annealing and oil annealing are widely used to prepare various types of materials, including plastics, metals, and glass for manufacturing. Annealing generally entails heating a material until it reaches an amorphous state and then cooling the material. As the material recrystallizes, internal stresses present within a body of the material before annealing are gradually relieved, helping to reduce the risk of stress-induced warping, crazing, and/or cracking of the material.

The aforementioned annealing techniques primarily differ based on the media in which the material rests while the material is heated and cooled. During air annealing, hot air (provided as atmospheric air or an inert gas such as nitrogen) is cycled around the material in an oven. In comparison, during oil annealing, the material is submerged in heated oil. In both air and oil annealing, the material is then cooled in a controlled fashion.

While current annealing methods may achieve some stress reduction in plastic materials, the plastic materials may still suffer from physical deformation when machined. One particularly difficult aspect to control with respect to conventional annealing methods concerns keeping the plastic material flat during the annealing process. When the plastic is not kept sufficiently flat during annealing, the plastic material may contort or “warp” upward after annealing and during machining. This warping effect may be seen in both metals and plastics, but the effect tends to be magnified for plastics owing to their inherently lower stiffness.

Annealing plastics after machining has been proven an ineffective method for minimizing deformation of the plastic. Furthermore, current methods for annealing during or after machining may cause unanticipated distortion of the plastic. Therefore, there is a need in the art for systems and methods that provide plastic materials that experience reduced warping during machining.

### SUMMARY

In some aspects, an annealing system is provided in the form of a fixture, a tank, a heating element, and a hoist system. The fixture is designed to receive a plastic material and includes a frame having an open end. The tank is designed to receive the fixture and retain water and is provided in the form of a base coupled to sidewalls extending upwardly and away from the base. The heating element is coupled to and disposed within the tank and is designed to impart the water within the tank with a first temperature. The hoist system is designed to transport the fixture into and out of the tank. In addition, the annealing system is designed to anneal the plastic material.

In some instances, the fixture further includes an end stop positioned on the frame opposite the open end.

In other instances, the fixture is positioned in the tank for a first predetermined time. The first temperature is at least about 65° C. and no more than about 95° C., and the first predetermined time is at least about 15 minutes.

In yet other instances, the first temperature is at least about 75° C. and no more than about 95° C., and the plastic material is positioned in the water provided in the tank for at least about 25 minutes.

In certain cases, the annealing system also includes a controller designed to activate the heating element and position the fixture in the tank for a first predetermined time. In some such cases, the first temperature is at least about 65° C. and no more than about 95° C. and the first predetermined time is at least about 15 minutes.

In some instances, the annealing system further includes a water treatment system fluidly coupled to the tank.

In some such instances, the water treatment system is designed to remove one or more impurities from the water within the tank, the one or more impurities selected from the group consisting of dissolved ions, minerals, and particulates.

In other instances, the plastic material is provided in the form of panels or sheets.

In yet other instances, the tank includes a door that is coupled to the tank by a hinge mechanism.

In additional instances, the fixture further includes a divider designed to prevent the plastic material from floating out of the fixture.

In other aspects, an annealing system for plastic materials is provided in the form of a fixture, a water tank, a hoist system, and a control system. The fixture is provided in the form of a frame designed to support a plastic material at an angle relative to a floor of the fixture. The water tank includes a heating element. The control system includes a controller and is in electrical communication with the fixture, the water tank, and the hoist system. The controller is designed to operate the heating element to heat water provided in the water tank to a first predetermined temperature and to direct the hoist system to submerge the plastic material in the water for a first predetermined time.

In some instances, the hoist system is provided with a motor in electrical communication with the controller.

In other instances, the first predetermined time and the first predetermined temperature are sufficient to anneal the plastic material.

In yet other instances, the control system further includes a display, a memory, and a power supply.

In yet other aspects, a method for annealing a plastic material includes the steps of providing a water tank and a fixture loaded with a plastic material, heating water within the water tank to a first temperature, transporting the fixture to the water tank and immersing the plastic material into the water for a first predetermined time, removing the fixture from the water tank, and cooling the plastic material to a second temperature.

In some instances, the fixture is provided in the form of a floor, joists, and support columns arranged substantially in the shape of a rectangular prism.

In other instances, the method further includes the step of adding one or more relief cuts to the plastic material.

In some such instances, the one or more relief cuts are made to the plastic material prior to cooling the plastic material to the second temperature.

In yet other instances, the method further includes the step of positioning the plastic material within a divider prior to positioning the plastic material into the fixture.

In some instances, the method further includes positioning the plastic material at an acute angle relative to a floor of the fixture. In some such instances, the acute angle is imparted with a value of at least about 65 degrees.

### DESCRIPTION OF THE DRAWINGS

FIG. 1 is a side elevational view of an annealing system including a tank, a hoist system, and a fixture, in which portions of the annealing system are drawn using break lines for the purposes of clarity, the annealing system constructed according to the teachings herein;

FIG. 2 is a partial perspective view of the annealing system of FIG. 1;

FIG. 3 is a front elevational view of the fixture of FIG. 1;

FIG. 4A is a left-side perspective view of the fixture of FIG. 1, the fixture loaded with plastic panels;

FIG. 4B is a left-side elevational view of the fixture of FIG. 1, the fixture loaded with plastic panels;

FIG. 5 is a front perspective view of a divider that may be utilized in the fixture of FIG. 1, the divider shown with a symbolic break in its length;

FIG. 6 is a left-side elevational view of the tank of FIG. 1 including a fixture positioned within an internal volume of the tank, the fixture and selected internal components of the tank drawn in dashed lines;

FIG. 7 is a top plan view of the tank of FIG. 1;

FIG. 8 is a front elevational view of the tank of FIG. 1 with a sidewall rendered transparently for clarity, the tank further including a gutter coupled thereto;

FIG. 9 is a left-side elevational view of the tank of FIG. 7, with a portion of a heater of the tank drawn in dashed lines;

FIG. 10 is another left-side elevational view of the tank of FIG. 7 including a door of the tank in an open configuration, with a portion of a heater of the tank drawn in dashed lines;

FIG. 11 is a schematic representation of a controller provided with the system of FIG. 1; and

FIG. 12 is a schematic representation of a method of annealing a plastic using the annealing system of FIG. 1.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the disclosure. Various modifications to the illustrated embodiments will be readily apparent to those skilled in the art, and the generic principles herein may be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, which are not necessarily to scale, and depict selected embodiments and are not intended to limit the scope of embodiments of the disclosure. Skilled artisans will recognize the examples provided herein have many useful alternatives and fall within the scope of embodiments of the disclosure.

According to the teachings herein, systems and methods for annealing plastic structures are provided. The annealing methods described herein may apply at least one heating cycle and at least one cooling cycle to a material before shaping, cutting, molding, or otherwise working the material. For example, a first heating cycle may be carried out at a first temperature and for a first time period, and a first cooling cycle may be carried out at a second temperature and for a second time period. In some instances, the first and second time periods may be adjusted to achieve a desired physical effect in the annealed materials. While the annealing systems and methods described herein may be utilized for any machinable materials, including metal and glass, the annealing systems and methods described herein are preferably applied to plastic materials and/or materials that will exhibit desired effects from annealing processes when the annealing process is carried out at a temperature of no more than about 100° C.

The entire annealing process or the heating and cooling cycles of the annealing process may be performed once or more than once. In such instances, the annealing processes (i.e., the heating cycle and the cooling cycle) may be performed consecutively or after arbitrary or predetermined time intervals.

In certain instances, the systems and methods described herein may be utilized to anneal a plastic material. The plastic material may comprise a single type of plastic (e.g., polyethylene) or a blend of plastics. Generally, the plastic materials may be provided as sheets or panels (i.e., as thin rectangular prisms) with a defined size, although the plastic materials may also be provided as other three-dimensional structures such as rods and tubes. For example, the plastic materials may be provided in stick profiles such as “1×2”, “2×2”, “2×4”, “2×6”, “2×8”, “2×10”, “2×12”, and/or other such sizes used in material production and construction industries, such as the lumber industry. In some instances, the plastic materials may be provided with at least one dimension (i.e. a length, width, and/or height) of between about 18 inches and about 24 inches. In some such instances, the plastic materials may be provided with at least one dimension (i.e. a length, width, and/or height) of about 12 feet. In some cases, the plastic materials may have one or more water-resistant and heat-resistant coatings, dyes, or other formulations applied to at least one surface of the plastic material.

In some instances, the plastic materials used in the annealing systems and methods described herein may comprise, consist essentially of, or consist of a thermoset polymer or plastic. The plastic materials used in the annealing systems and methods described herein may comprise, consist essentially of, or consist of a thermoplastic. In multiple instances, the plastic material may be provided in the form of high-density polyethylene, low-density polyethylene, polyurethane, nylon, polycarbonate, or acrylic. In various instances, the plastic material may comprise high-density polyethylene. The annealing systems and methods described herein may be used with any type of plastic.

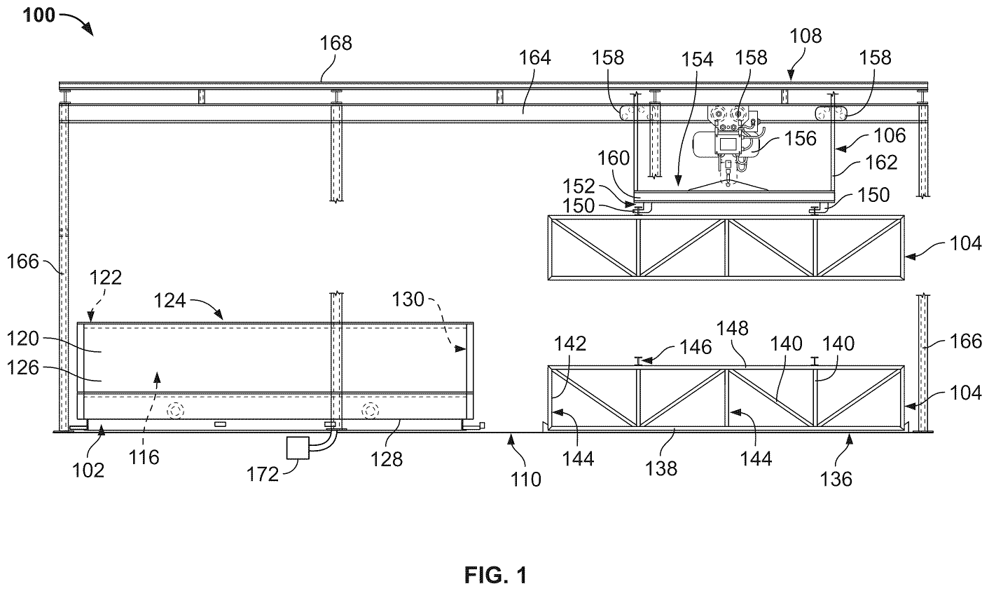

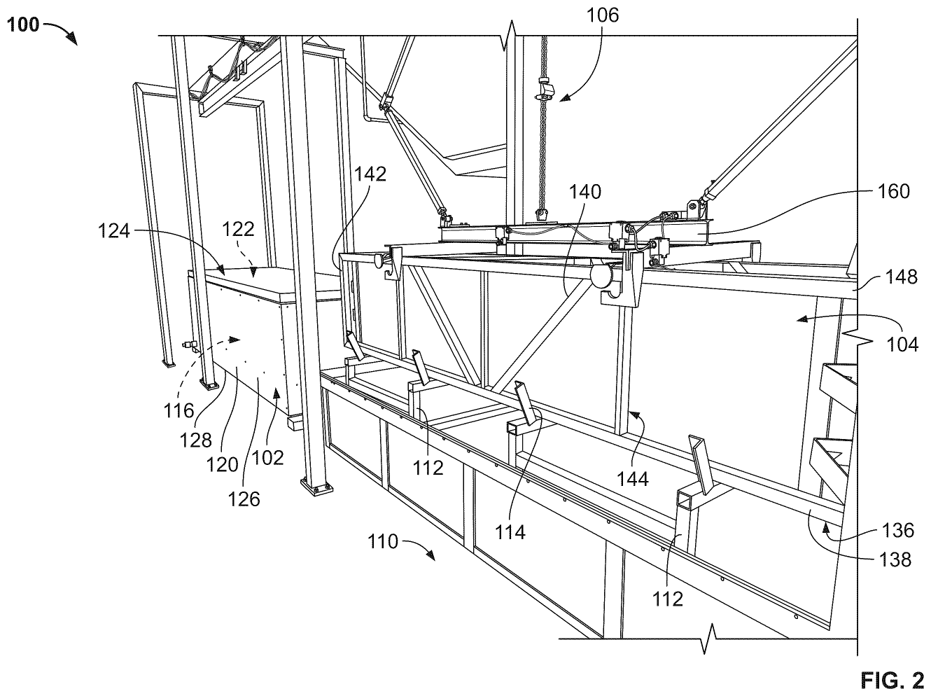

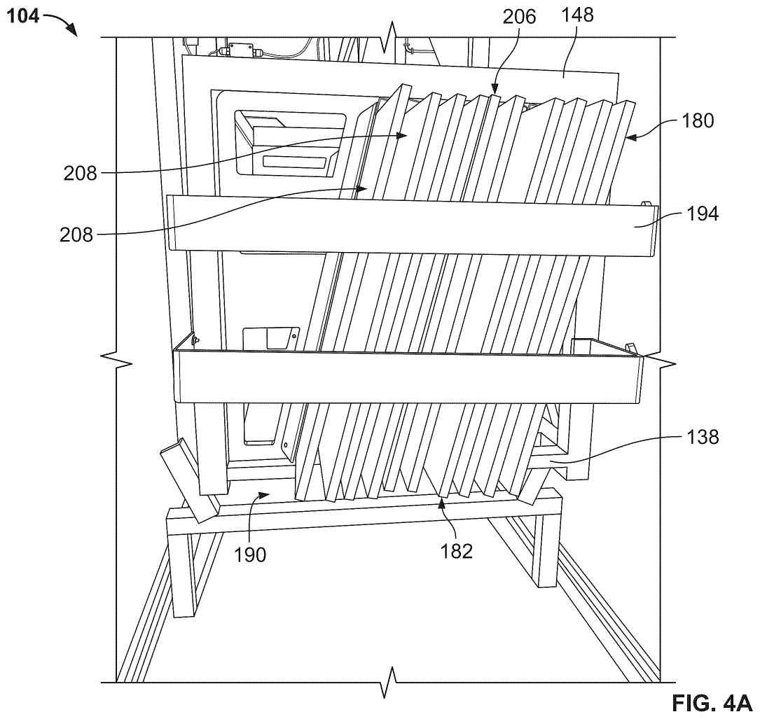

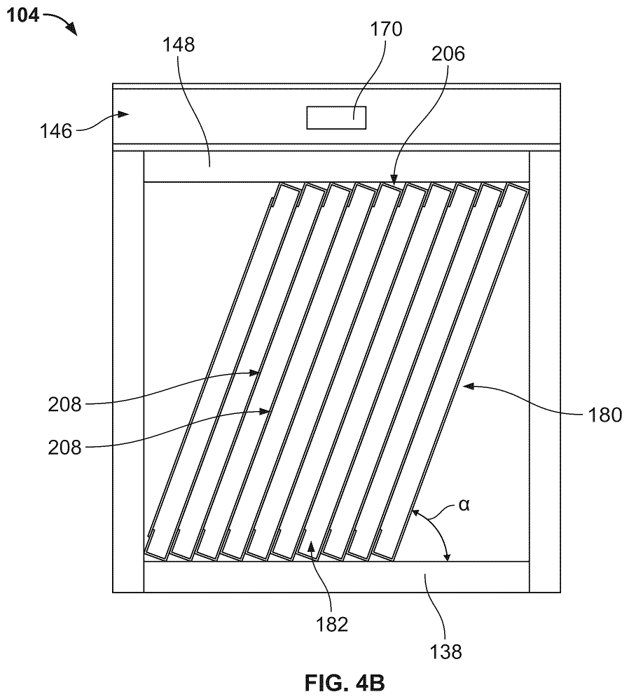

Referring now to FIGS. 1 and 2, an annealing system 100 is provided in the form of a tank 102, one or more fixtures 104, a hoist system 106, and a rail system 108 (the rail system 108 not shown in FIG. 2). The annealing system 100 may be utilized to anneal various materials, such as plastic panels or sheets (see, e.g., plastic panels 180 of FIG. 4A), before the materials are machined. For example, the annealing system 100 may be used to anneal high-density polyethylene. In certain instances, the plastic panels annealed by the annealing system 100 may be loaded into or placed on the fixtures 104 during the annealing process. Generally, the fixtures 104 may be positioned proximate or adjacent to the tank 102, but the fixtures 104 may also be positioned in an alternative location (e.g., a separate warehouse, not illustrated) and transported to the annealing system 100 as needed. The rail system 108 may be positioned proximate to the tank 102 and may facilitate transport of the fixtures 104 (and thus the plastic panels) to, into, out of, and/or away from the tank 102. For example, relative to a surface 110 upon which the tank 102 is positioned, the rail system 108 may be positioned above the tank 102. The hoist system 106 may be coupled to or provided with the rail system 108 such that the fixtures 104 may be lifted upwardly and away from the surface 110, transported along the rail system 108, placed into the tank 102, removed from the tank 102, and/or moved downwardly and placed upon the surface 110. In some instances, the tank 102 may be sized and shaped such that only a single fixture 104 may be positioned in the tank 102 during the annealing process, although in other instances the tank 102 may be sized and shaped to retain two or more fixtures 104. In various instances, each fixture 104 may be positioned on the surface 110 proximate to the tank 102, the hoist system 106, and/or the rail system 108, selectively coupled to the hoist system 106, and/or positioned within the tank 102.

In certain instances, the annealing system 100 may only be provided with a single fixture 104. In some instances, the annealing system 100 may be provided with more than one tank 102, hoist system 106, and rail system 108. In addition, regardless of the number of components provided as part of the annealing system 100, the tank 102, the fixture 104, the hoist system 106, the rail system 108, and other components of the annealing system 100 may be provided within a building (e.g., a warehouse, a manufacturing facility). Furthermore, it is to be understood that various features of the annealing system 100, such as the hoist system 106 or the rail system 108, may be omitted. In such instances, the plastic sheets may be transferred to the tank using other mechanisms or methods than those described herein.

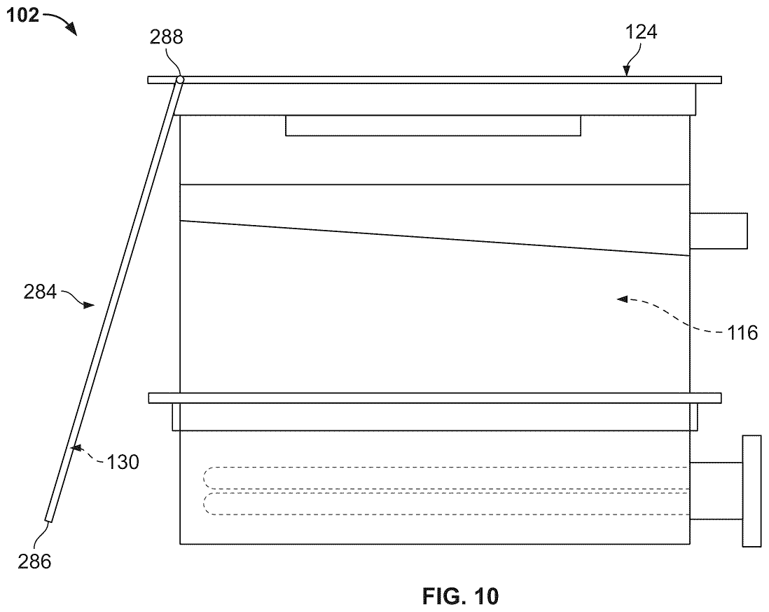

The tank 102 may be provided in the form of a body 120 including an aperture 122 provided within a top surface 124 of the body 120, and a lid or door designed to selectively open and close the aperture 122 (see FIG. 10). The body 120 may be provided in the shape of a substantially hollow rectangular prism, although the body 120 may also be provided in other shapes and forms (e.g., a substantially hollow cube, a substantially hollow cylinder, and other three-dimensional structures). For example, the tank 102 may be provided in the form of an open-top, rectangular cuboid shell. The body 120 may include sidewalls 126 that extend upwardly and substantially perpendicularly from a base 128. For example, if the base 128 is provided as a rectangular prism, one sidewall 126 may be coupled to each side of the base 128. The body 120 may be composed of any durable material able to withstand prolonged exposures to temperatures of at least about 100° C. and/or a material that will not rust upon prolonged exposure to water. For example, the body 120 may be primarily or substantially composed of stainless steel.

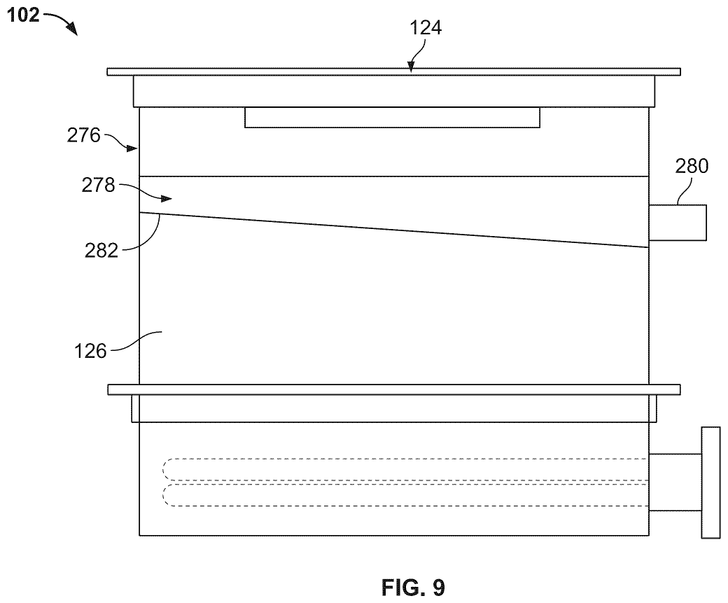

In certain instances, the tank 102 may include an insulating material 130. The insulating material may be designed to help the tank 102—and the water disposed in the tank 102—retain heat. The insulating material 130 may be provided within the sidewalls 126 and/or the base 128 of the body 120. In addition, when a structure is provided that may open and close the tank (e.g., a door or a lid), the insulating material 130 may also be provided in the structure (e.g., see FIG. 9). In some instances, the insulating material 130 may be provided as an air gap within the sidewalls 126 and/or the base 128. In other instances, the insulating material 130 may be provided as fiberglass, an insulating foam, or other similar materials.

The body 120 of the tank 102 may be imparted with an internal volume 116 sized such that the plastic panels and/or fixtures 104 may be positioned and retained therein. In some instances, the base 128 and the sidewalls 126 may define the internal volume 116 of the body 120. In certain instances, the internal volume 116 of the tank 102 may be imparted with a value of at least about 20,000 L, or at least about 25,000 L, or at least about 30,000 L, or at least about 35,000 L, or at least about 40,000 L, or at least about 45,000 L, or at least about 50,000 L, although the internal volume of the tank 102 may also be somewhat smaller or even larger than these values. In certain instances, during the annealing process, the internal volume 116 may be partially, substantially, or completely filled with water.

The fixture 104 may be provided in the form of a frame 136 including a floor 138, joists 140, and columns 142 arranged into a rectangular prism shape, although the frame 136 may be provided in other shapes and forms (e.g., as a cubic structure or another three-dimensional structure). The fixture 104 may be designed to retain the plastic panels during the annealing process. Specifically, when the annealing process is being carried out, the plastic panels may be positioned upon surfaces 144 of the columns 142 such that the adjacent surfaces of the plastic panels are substantially parallel with one another (e.g., see the arrangement of the plastic panels 180 in FIGS. 4A and 4B). Advantageously, arranging the plastic panel in this manner may help reduce the internal stress within the plastic panels during and after the annealing process, which in turn will allow the plastic panels to more easily be machined without warping. For example, reducing the internal stress may help the plastic materials sit flat on a machining bed (not illustrated) as compared to non-annealed plastic materials, which in turn facilitates the production of manufactured plastics imparted with little to no warping. In addition, as will be further described with reference to FIGS. 2 and 4, the fixtures 104 may include structures or components that are designed to help prevent the plastic panels from floating out of the fixtures 104 during the annealing process.

Referring still to FIGS. 1 and 2, the frame 136 may be composed of any durable material able to withstand prolonged exposures to temperatures of at least about 100° C. and/or a material that will not rust upon prolonged exposure to water. For example, the frame 136 may be primarily or substantially composed of stainless steel. In addition, the components of the frame 136 (e.g., the floor 138, the joists 140, and/or the columns 142) may be provided in the form of cylindrical bars, bars shaped as rectangular prisms, I-bars, H-bars, and other similar structures known in the art. The frame 136 may be sized such that the fixture 104 may be completely or substantially retained within the internal volume 116 of the tank 102 when the fixture 104 is inserted into the tank 102. Thus, the size of the tank 102 and/or the fixture 104 may help ensure that the plastic panels loaded onto the fixture 104 are completely or substantially submerged in the water during the annealing process.

The frame 136 may further include one or more coupling members 146 extending upwardly and away from a top section 148 of the frame 136. Each coupling member 146 may include an aperture (not shown) extending partially or completely through the coupling member 146. If only a single coupling member 146 is provided on the frame 136, the coupling member 146 may be positioned at or near a horizontally defined center of gravity of the fixture 104 to help provide stability to the fixture 104 when the fixture 104 is transported by the hoist system 106. If more than one coupling member 146 is provided, the coupling members 146 may be positioned on the top section 148 such that the horizontally defined center of gravity of the fixture 104 is provided between at least two of the coupling members 146.

Each coupling member 146 may be designed to couple to or receive a respective hook member 150 of the hoist system 106. The hook member 150 may extend downwardly and away from a bottom portion 152 of the hoist system 106. The hook member 150 of the hoist system 106 may be provided in the form of a J-hook, although the hook member 150 may also be provided in other shapes and forms such that the hook member 150 is couplable to the fixture 104. In some instances, the hook member 150 may be received in the aperture of the coupling members 146 such that the hoist system 106 may raise and lower the fixture 104.

As shown in FIGS. 1 and 4B, the coupling member 146 may be provided as an I-beam that extends across the top section 148 of the frame 136, although the coupling member 146 may also be provided in other forms and shapes. As shown in FIG. 4B, the coupling member 146 may include an aperture 170 extending at least partially therethrough. As described with reference to FIG. 1, the aperture 170 of the coupling member 146 may be designed to receive the hook member 150 of the hoist system 106 such that the fixture 104 can be more easily transported from place to place.

Referring again to FIG. 1, the hoist system 106 may further include a chassis 154, a motor 156, and wheel systems 158. The chassis 154 may be provided in the form of one or more load bars 160 and substantially vertical support bars 162. The support bars 162 may be extendible and retractable to help facilitate the movement of the hook members 150 and the load bar 160 upwardly and downwardly, relative to the surface 110. In some instances, the support bars 162 may be in communication with the motor 156 such that the support bars 162 may be extended and retracted via actuation of the motor 156. The hook members 150 of the hoist system 106 may be moved downwardly and towards the surface 110 to facilitate coupling of each coupling member 146 of the fixture 104 to respective hook members 150 of the hoist system 106. In turn, this may allow the fixture 104 to be raised and lowered relative to the surface 110.

In some instances, the hoist system 106 may be provided with the motor 156, although in alternative instances the hoist system 106 may be provided without a motor. The motor 156 may be provided as any motor known in the art, including any form of an electrical motor. In such instances, the annealing system 100 may be in electrical communication with a source of electricity (not illustrated) that may be used to power the motor 156. When the motor 156 is activated, the motor 156 may provide a lift force that may extend and retract the load bars 160 of the hoist system 106, including when the fixture 104 is coupled to the hoist system 106.

The hoist system 106 may be coupled to the rail system 108 via the wheel systems 158. The wheel systems 158 may facilitate movement of the hoist system 106, and components coupled to the hoist system 106, along the rail system 108. The wheel systems 158 may be sized and shaped such that the wheel systems 158 may be retained within a girder 164 of the rail system 108. In some instances, power provided by the motor 156 may be utilized to turn the wheel systems 158 in a clockwise or a counterclockwise direction such that the hoist system 106 may move substantially parallel to the rail system 108. In other instances, power from the motor 156 may only be provided to a single set or a defined subset of the wheel systems 158 provided with the hoist system 106. In yet other instances, power used to turn the wheels of the wheel systems 158 may be provided by another component associated with the annealing system 100, such as an electrical source (not illustrated) that is in electrical communication with the annealing system 100.

Referring still to FIG. 1, in some instances, the rail system 108 may be provided with a single girder 164 to which the hoist system 106 is coupled. Thus, in such instances, the rail system 108 may be provided in the form of a monorail system. In other instances, the rail system 108 may be provided with multiple girders 164 to which the hoist system 106 is coupled. In certain instances, the girder 164 of the rail system 108 may be substantially parallel to the surface 110.

The rail system 108 may also be provided with support columns 166 and a support beam 168. The support columns 166 and the support beam 168 may be designed to support the weight of the rail system 108, the hoist system 106, and any fixtures 104 coupled to the hoist system 106. The support columns 166 may abut the surface 110 and extend substantially perpendicularly to the surface 110 and couple to the girder 164. In comparison, the support beam 168 may be positioned above the girder 164 and extend substantially parallel to the girder 164. The support beam 168 may in turn be coupled to both the girder 164 and a ceiling or other support structure (not illustrated) provided proximate or adjacent to the annealing system 100. The support columns 166 and the support beam 168 may be provided in the form of steel I-beams, steel H-beams, or other similar components. In alternative instances, either the support columns 166 or the support beam 168 may not be provided in the annealing system 100. In yet other alternative instances, the annealing system 100 may include more support columns 166 and/or support beams 168 than illustrated herein.

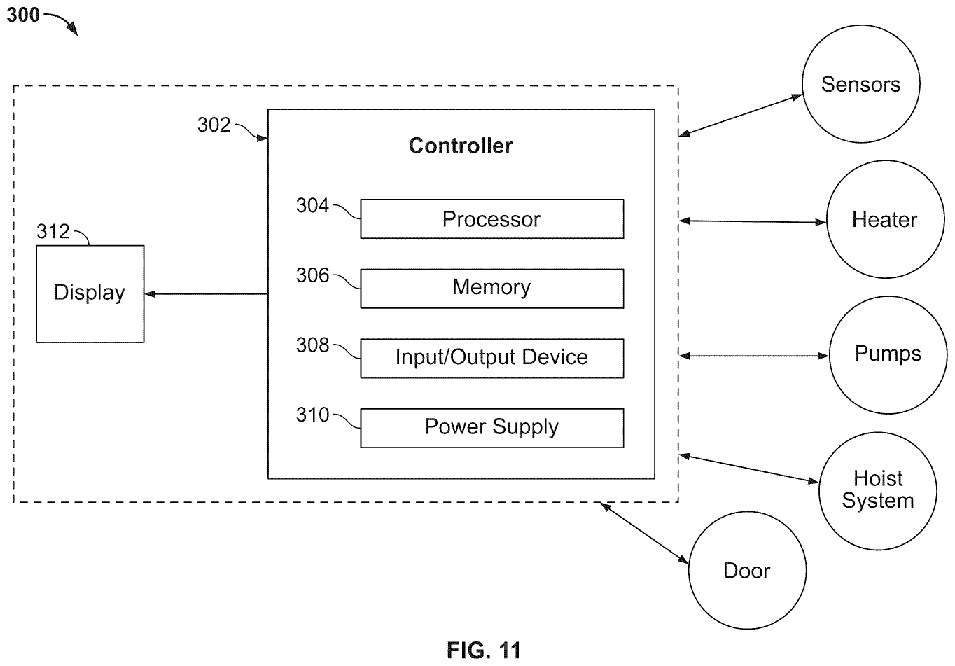

In certain instances, when the plastic panels are being transported from place to place in the annealing system 100, the plastic panels may be directly picked up by the hoist system 106. Preferably, however, the plastic panels are loaded onto or positioned in the fixture 104 when the plastic panels are transported from place to place in the annealing system 100 (e.g., when transported to and/or from the tank 102). In some instances, the plastic panels may be loaded into and unloaded from the fixture 104 at the same location (i.e., a “home” position) in the annealing system 100. In some such instances, the annealing system may include one or more notifying means (e.g., one or more visual indicators or one or more audio indicators) to indicate to an operator that the plastic panels are to be loaded and/or unloaded from the fixture 104. For example, the annealing system 100 may include one or more andon lights designed to provide a visual alert to the operator when the annealing system 100 has moved the fixture 104 from the tank 102 and back to the home position. The andon lights (or other notifying means provided with the annealing system 100) may be in communication with a control system (e.g., a control system 300 of FIG. 11) that is designed to activate the notifying means when the control system detects that the fixture 104 has returned to the home position after the plastic sheets have been heated. In other instances, the control system (e.g., the control system 300 of FIG. 11) may provide a notification to a user device when the plastic panels are ready to be unloaded from and/or loaded into the fixture 104.

During the annealing process, the internal volume 116 of the tank 102 may be partially, substantially completely, or completely filled with water. The water in the tank 102 may be imparted with a first temperature. In some instances, the first temperature may be imparted with a value of at least about 65° C. to no more than about 95° C., although the first temperature may also be somewhat less or somewhat greater than these values. For example, the first temperature may be imparted with a value of at least about 70° C. to no more than 90° C., or a value of at least about 80° C. to no more than 85° C. As an additional example, the first temperature may be imparted with a value of at least about 66° C., or at least about 67° C., or at least about 68° C., or at least about 69° C., or at least about 71° C., or at least about 72° C., or at least about 73° C., or at least about 74° C., or at least about 75° C., or at least about 76° C., or at least about 77° C., or at least about 78° C., or at least about 79° C., or at least about 81° C., or at least about 82° C., or at least about 83° C., or at least about 84° C., or at least about 86° C., or at least about 87° C., or at least about 88° C., or at least about 89° C., or at least about 91° C., or at least about 92° C., or at least about 93° C., or at least about 94° C. In certain cases, the first temperature may be imparted with a value falling between any minimum or maximum value described above. In certain instances, the first temperature may be imparted with a range of values bounded by any minimum value and any maximum value as described above.

In certain cases, the water may be held at a substantially constant temperature when the plastic panels are submerged in the water of the tank 102. In other instances, the temperature of the water may vary when the plastic panels are submerged in the tank. In certain instances, the water in the tank 102 may be at ambient temperature when the plastic panels are first submerged in the water. In such instances, the water in the tank 102 may be heated to the first temperature after the plastic panels are positioned in the tank 102. In other instances, the water may be heated to the first temperature before the plastic panels are positioned within the tank 102.

In some instances, a water treatment system 172 may be provided in fluid communication with the tank 102. The treatment system 172 may be provided in the form of any suitable system designed to filter water. For example, the treatment system may generate a filtered water from the unfiltered water by removing hardness-imparting minerals and other impurities such that film does not develop on the surface of the plastic panels and/or components of the annealing system 100. In some instances, the water treatment system 172 may remove impurities selected from the group consisting of dissolved ions, minerals, and particulates from the unfiltered water to generate the filtered water. For example, the treatment system 172 may in some cases be a filter containing a membrane. Examples of appropriate membrane filters include but are not limited to a reverse osmosis (RO) membrane, a microfiltration (MF) membrane, an ultrafiltration (UF) membrane, a particulate membrane, an electrodialysis membrane system, and similar known membrane filters. In some instances, the treatment system 172 may comprise a combination of one or more of an RO membrane, an NF membrane, a UF membrane, an MF membrane, a particulate membrane, and/or an electrodialysis membrane, which may be disposed in parallel or in series. The one or more membranes in the combination of membranes may be included within a single housing, in separate housings, or a combination thereof.

In various instances, the water in the tank 102 may be substantially free of dissolved ions, minerals, and other particulates upon entry into the tank 102 prior to filtration by the treatment system 172. In other instances, the water in the tank 102 may contain a first concentration of dissolved ions, minerals, and other particulates prior to filtration by the treatment system 172 and may be imparted with a second concentration of dissolved ions, minerals, and other particulates after filtration, wherein the second concentration is substantially lower than the first concentration. In yet other instances, the treatment system 172 may feature a bypass mechanism such that water may directly enter the tank 102 without filtration by the treatment system 172.

In various instances, the treatment system 172 may further include one or more sensors for detecting a status of the unfiltered water entering the treatment system 172. For example, the one or more sensors may be provided in the form of detectors, testing kits, electrodes, probes, and other suitable devices designed to measure a property of the water, such as pH, hardness, flow rate, etc. In some such instances, the treatment system 172 may feature an internal controller such that unfiltered water is filtered upon a determination by the one or more sensors that the unfiltered water requires treatment.

In some instances, the treatment system 172 may include additional components for treating either the unfiltered and/or the filtered water entering the tank 102. In certain instances, the treatment system 172 may include at least one feeder to introduce chemical additives into the water. For example, the feeder may release an acidic or basic solution when it is determined that the water is of non-neutral or undesired pH.

During the annealing process, the plastic panels may be submerged in the water of the tank 102 for a first predetermined time. The first predetermined time may be defined as the total amount of time that the plastic panels are submerged in the tank 102. Alternatively, the first predetermined time may be defined as the total amount of time the plastic panels are imparted with the first temperature. The first predetermined time may be imparted with a value of at least about 20 minutes to no more than about 60 minutes, although the first predetermined time may be somewhat less than or even greater than these values. For example, the first predetermined time may be imparted with a value of about 25 minutes to about 50 minutes, or about 30 minutes to about 40 minutes, or about 30 minutes to about 35 minutes. As an additional example, the first predetermined time may be imparted with a value of at least about 20 minutes, or at least about 25 minutes, or at least about 30 minutes, or at least about 35 minutes, or at least about 40 minutes, or at least about 45 minutes, or at least about 50 minutes, or at least about 55 minutes, or at least about 60 minutes. In certain cases, the first predetermined time may be imparted with a value falling between any minimum or maximum value described above. In certain instances, the first predetermined time may be imparted with a range of values bounded by any minimum value and any maximum value as described above.

During the annealing process, the plastic panels may be cooled. Specifically, after the plastic panels are removed from the tank 102, the plastic panels may begin to cool to a second temperature. The second temperature may be imparted with a value that is less than the first temperature. In certain instances, the second temperature may be substantially equal to the ambient temperature of the environment in which the annealing system 100 is located (e.g., the ambient temperature of the warehouse or the manufacturing facility in which the annealing system 100 is located). In some instances, the ambient temperature may be controlled via a heating system or a cooling system. In such instances, the ambient temperature may be maintained within a predetermined range of a setpoint value (e.g., a range of about 10° C. from the setpoint value, or a range of about 5° C. from the setpoint value, or a range of about 3° C. from the setpoint value). In other instances, the ambient temperature is not controlled.

In various instances, the second temperature may be imparted with a value of at least about 0° C. to no more than about 30° C., although the second temperature may also be somewhat less or even greater than these values. For example, the second temperature may be imparted with a value of at least about 5° C. to no more than about 25° C., or at least about 10° C. to no more than about 25° C., or at least about 15° C. to no more than about 25° C. In certain cases, the second temperature may be imparted with a value falling between any minimum or maximum value described above. In certain instances, the second temperature may be imparted with a range of values bounded by any minimum value and any maximum value as described above. In certain cases, the ambient temperature may be held at a substantially constant value when the plastic panels are being cooled. In other instances, the ambient temperature may vary as the plastic panels are being cooled.

In particular instances, after removal from the tank 102 and prior to subsequent cooling, the plastic panels may be subjected to further processing, such as shaping, molding, or otherwise working the material, while still warm. In some instances, one or more of the plastic panels may be imparted with one or more features to prevent future tearing, bending, or deformation when cutting. For example, in one such instance, relief cuts in the form of small incisions may be made in the one or more plastic panels while the plastic panels are softened and pliable from annealing. In other such instances, a portion (e.g., a corner) of the one or more plastic panels may instead be bent at an angle of approximately 0 degrees to approximately 90 degrees after a relief cut is made on the plastic panel (e.g., on the backside of the plastic panel). In such instances, bending a portion (e.g., a corner) of the plastic panel may advantageously complement a natural bending of the plastic panel, further reducing internal stress experienced by the plastic panels when later cutting or molding is performed.

In certain instances, the plastic panels may be cooled for a second predetermined time. In other instances, after the plastic panels are removed from the tank 102, the plastic panels may be retained on the fixture 104 for the second predetermined time before being removed. The second predetermined time may be imparted with a value of at least about 1 minute to at least about 120 minutes, although the second predetermined time may be somewhat less or even greater than these values. For example, the second predetermined time may be imparted with a value of about 2 minutes to about 90 minutes, or about 25 minutes to about 50 minutes, or about 30 minutes to about 40 minutes, or about 30 minutes to about 35 minutes. As an additional example, the second predetermined time may be imparted with a value of at least about 20 minutes, or at least about 25 minutes, or at least about 30 minutes, or at least about 35 minutes, or at least about 40 minutes, or at least about 45 minutes, or at least about 50 minutes, or at least about 55 minutes, or at least about 60 minutes. In certain instances, the second predetermined time may be imparted with a value of at least about 1 hour, or at least about 2 hours, or at least about 4 hours, or at least about 12 hours, or at least about 24 hours, or at least about 48 hours. As an additional example, the second predetermined time may be imparted with a value of about 20 hours to about 35 hours, or about 24 hours to about 31 hours, or about 26 hours to about 30 hours. In certain cases, the second predetermined time may be imparted with a value falling between any minimum or maximum value described above. In certain instances, the second predetermined time may be imparted with a range of values bounded by any minimum value and any maximum value as described above.

An exemplary annealing process utilizing the annealing system 100 of FIG. 1 is provided. During the annealing process, at least one plastic panel, e.g., a plastic panel in the form of a plastic sheet, may be positioned on or within the fixture 104. For example, at least 10 plastic panels may be loaded onto the fixture 104. Then, the load bar 160 of the hoist system 106 may be at least partially received within the coupling member 146 of the fixture 104. Once the hoist system 106 is coupled to the fixture 104, the hoist system 106 may move the fixture 104 upwardly and away from the surface 110. The hoist system 106 may then move along the rail system 108 and substantially parallel to the surface 110 until the hoist system 106 is above the tank 102. The fixture 104 may then be lowered into the tank 102.

Either before the fixture 104 is lowered into the tank 102 or after the fixture 104 is lowered into the tank 102, the water disposed in the tank 102 may be imparted with the first temperature. After the plastic panel has been submerged in the water of the tank 102 for the first predetermined time, the fixture 104 may be removed from the tank 102 by the hoist system 106. To do so, the hoist system 106 may raise the fixture 104 upwardly and out of the tank 102. In some instances, the hoist system 106 may remain positioned above the tank 102 for a least a portion of the second predetermined time to allow water to drip off of the plastic panel and/or the fixture 104 and back into the tank 102. Finally, the hoist system 106 may then return the fixture 104 to a position proximate or adjacent to the tank 102, such as the home position.

In some instances, the hoist system 106 may be designed to quickly raise and remove the fixture 104 from the tank 102 and return the fixture 104 to the home position to help minimize a temperature differential within the fixture 104 before the plastic sheets are unloaded. Without being bound to a particular theory, it is believed that exposure of the previously submerged plastic panels to the air may cause rapid cooling of the plastic panels, in particular the topmost and bottommost plastic panels within the fixture 104, owing to the presence of warm sheets on one side of the panels and cooled air on the other. In addition, the cooled air may rush into spaces provided between the plastic sheets, thereby leading to further temperature differences. Thus, the hoist system 106 may in some such instances be optimized in order to reduce the time taken to extract the fixture 104 containing the plastic panels from the tank 102, thereby allowing the plastic panels to be unloaded from the fixture 104 more quickly.

As the plastic panels are unloaded from the fixture 104, the plastic panels may be arranged in a stacked configuration (i.e., a first plastic panel may be laid flat in a particular location, a second panel may be positioned and laid flat upon the first panel, a third panel may be positioned and laid flat upon the second panel, and so on). Arranging the plastic panels in such a manner may help prevent warping of the panels during cooling. In some instances, however, asymmetric cooling of the plastic panels may occur, particularly with respect to the first panel (i.e., the bottommost panel) and the final panel (i.e., the topmost panel) in the stacked configuration. The asymmetric cooling may occur because the first and final panels are exposed to cooler environments than the other panels arranged in the stacked configuration. To help prevent warping that may occur due to the asymmetric cooling, a compressive force may be applied to the panels. For example, a pressing plate or object (e.g., a pallet) may be positioned upon the topmost panel, which in turn may apply a compressive force to the stacked configuration of plastic panels due to the weight of the pressing plate or object. As an additional example, the compressive force may be applied via ratchet straps that may be arranged to provide a downwardly-directed force on the stacked configuration of plastic panels. In some instances, the compressive force may be applied to the plastic panels for the second predetermined time. It is to be appreciated that other methods of applying a compressive force to the stacked configuration of plastic panels may also be used.

In some instances, after the plastic panels have cooled, the annealing process may be complete. In other instances, a second heating cycle and a second cooling cycle may be carried out to complete the annealing process. In yet other instances, more than two heating and cooling cycles may be used to complete the annealing process. After the annealing process is complete, the plastic panels may be removed from the fixture 104.

Referring now to FIG. 2, the annealing system 100 is further illustrated, further comprising optional risers 112 underneath the fixture 104. The risers 112 may be provided in the form of horizontally oriented joists or panes that may allow an operator to load and unload the fixture 104 with the plastic panels with greater ease or comfort. For example, the risers 112 may elevate the fixture 104 such that the fixture 104 may be accessed by the operator at an ergonomic height.

The risers 112 may in some instances additionally include anchors 114 for preventing tipping of the fixture 104 when the fixture 104 is placed upon the risers 112. Advantageously, the risers 112 in combination with the anchors 114 may ensure stability of the fixture 104 when plastic panels are being directly slid into and out of the fixture 104 from an adjacent cart at the same height (not shown). In some such instances, the anchors 114 may be fixed in position. Alternatively, the anchors 11 may be rotated, depressed, or otherwise removed when movement of the fixture 104 is necessary.

In some instances, the surface 110 may feature provisions (not shown) to mitigate risk of a slip or fall near the home position where loading and unloading take place. Such safety provisions may take the form of, for example, anti-slip tape, rubber mats, barricades, or bright markings indicating a no-cross zone. In some such instances, the safety provisions may be present in front, behind, or to the side of either the tank 102 or the fixture 104. In other such instances, the safety provisions may be present in front, behind, or to the side of both the tank 102 and the fixture 104.

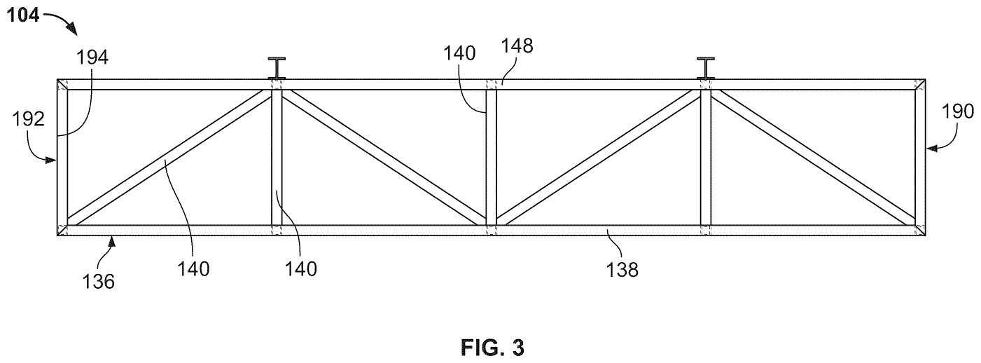

Referring now to FIG. 3, the fixture 104 is further illustrated. In some instances, the frame 136 of the fixture 104 may include a loading end 190 positioned opposite a non-loading end 192. The loading end 190 of the fixture 104 may be substantially open such that plastic panels may be inserted into the fixture 104 prior to the annealing process and/or removed from the fixture 104 after the annealing process. In such instances, when the fixture 104 is positioned adjacent to the tank 102, the non-loading end 192 may be proximate to the tank 102 while the loading end 190 may be positioned opposite the tank 102.

In some instances, the non-loading end 192 of the fixture 104 may include an end stop 194. The end stop 194 may be provided in the form of a thin sheet (e.g., as a thin, substantially rectangular prism). The end stop 194 may be removably coupled to the frame 136 such that the non-loading end 192 may be converted to a loading end similar to the loading end 190, or the end stop 194 may not be removable from the frame 136. The end stop 194 may act as a barrier to help prevent the dislocation or movement of plastic panels out of the interior of the fixture 104.

The end stop 194 may be composed of substantially the same material as the other components of the fixture 104. In addition, the end stop 194 may be composed of any durable material able to withstand prolonged exposures to temperatures of at least about 100° C. and/or a material that will not rust upon prolonged exposure to water. For example, the end stop 194 may be primarily or substantially composed of stainless steel.

Referring still to FIG. 3, the frame 136 of the fixture 104 may be supported by one or more joists 140. Each of the joists 140 may be coupled to the floor 138 and the top section 148 of the fixture 104. In some instances, only a single joist 140 may be provided with the frame 136. In other instances, two, three, four, or even more joists 140 may be provided in the fixture 104. The joists 140 may be coupled at a first end and a second end to the floor 138 and the top section 148 of the fixture 104, respectively.

In some instances, the lengths of the joists 140 may be substantially identical. In other instances, the lengths of the joists 140 may be different. In addition, the joists 140 may be coupled orthogonally to the floor 138 and the top section 148 and/or the joists 140 may be coupled to the floor 138 and the top section 148 at acute and obtuse angles relative to the floor 138.

While the arrangement of the structural components of the fixture 104 (e.g., the floor 138, the joists 140, and the top section 148) have been described in particular arrangements with reference to FIG. 2, other arrangements of the structural components of the fixture 104 could also be utilized. For example, the structural components could be coupled in any orientation and utilize any fastening method deemed suitable for the application when creating the fixture 104.

Referring now to FIGS. 4A and 4B, one or more of the plastic panels 180 may be inserted into the fixture 104, e.g., through the loading end 190. In some instances, a single plastic panel 180 may be inserted into the fixture 104 for annealing. In other instances, a plurality of plastic panels 180 may be inserted into the fixture 104. After the plastic panels 180 are inserted into the fixture 104, a first end 182 of the plastic panels 180 may abut the floor 138 and a second end 206 of the plastic panels 180 may abut the top section 148. In addition, the plastic panels 180 may abut one another such that a surface 208 of one plastic panel 180 is substantially contiguous and substantially parallel with the surface 208 of an adjacent plastic panel 180 (see FIG. 4B), although gaps may be provided between adjacent plastic panels 180 (see FIG. 4A). Arranging the plastic panels 180 in the fixture 104 as described herein may help the surfaces 208 of the plastic panels 180 remain flat during the annealing process to help prevent the plastic panels 180 from warping during and after annealing.

In certain instances, the plastic panels 180 may be inserted into the fixture 104 such that the surfaces 208 are substantially perpendicular to the floor 138. In other instances, as provided in FIG. 4B, the plastic panels 180 may be inserted into the fixture 104 such that an acute angle is provided between the surfaces 208 and the floor 138. For example, an angle α may exist between the surface 208 of the plastic panels 180 and the floor 138. The angle α may be imparted with a value of between about 0 and about 90 degrees when the at least one plastic panel 180 is loaded into the fixture 104. The angle α may be imparted with a value of at least about 0 degrees to no more than about 90 degrees or a value of at least about 45 degrees to no more than about 75 degrees to help prevent movement of the plastic panels 180 as the plastic panels 180 are being transported before, during, and after the annealing process. For example, the angle α may be imparted with a value of at least about 65 degrees when the plastic panels 180 are inserted into the fixture 104. In other instances, the angle α may be imparted with a value less than or greater than the values recited herein.

In certain instances, one or more compressive members (not shown) may be provided in the fixture 104. The one or more compressive members may be designed to apply a force to the plastic panels 180 in the event that the plastic panels 180 remain in the fixture 104 during the cooling process. For example, the one or more compressive members may be positioned at one or more of the end 190, the end 192, a bottom portion, or a top portion of the fixture 104. In addition, the one or more compressive members may be designed to abut the plastic panels 180. The one or more compressive members may exert pressure upon the plastic panels 180 leaning against the ends 190, 192 such that the freshly heated plastic panels 180 may cool more uniformly, preventing the plastic panels 180 from warping during cooling. Without being bound to a particular theory, the stacked plastic panels 180 may act as a solid thermal mass upon heating, wherein plastic panels near the middle of the stack may cool uniformly owing to placement between warm sources of constant pressure. In contrast, the outermost plastic panels 180 within the fixture 104 may deflect upward toward the cooler air due a lack of such an adjacent warm, heavy force, thereby leading to warping. Thus, the compressive force may help the entire collection of plastic panels 180 cool as a solid thermal mass during the second predetermined time (e.g., about 26 hours to about 30 hours).

In some instances, the compressive force may be applied due to the weight of an object positioned upon the plastic panels 180. For example, the compressive force may be applied by a pallet having a smooth surface. In some such instances, the smooth surface of the pallet is insulating. For example, the smooth surface may be made of plastic. In certain instances, the pallet may further include additional means to apply force to the plastic panels 180 underlying the pallet. For example, the pallet may feature one or more ratcheting straps designed to contain and compress the plastic panels 180. In other instances, the pallet may instead include other mechanical means for attachment, such as cam buckles, bungee cords, chains, and the like. In preferred instances, the compressive force removes air gaps above, below, and between the plastic panels 180 to minimize unwanted curling of the plastic panels 180.

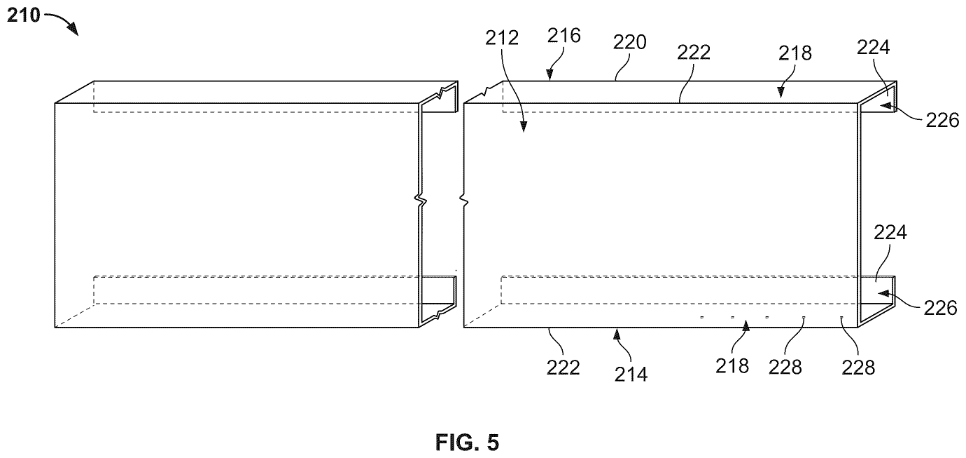

Turning next to FIG. 5, in some instances, a divider 210 may be coupled to or provided as part of the fixture 104 of FIGS. 1-4B. For example, the divider 210 may be positioned within the frame 136 of the fixture 104, or the divider 210 may be coupled to the outside of the frame 136. The divider 210 may be used to help prevent the movement of the plastic panels 180 (see FIG. 3) within the fixture 104. For example, the divider 210 may help prevent the plastic panels from floating out of the fixture 104 when the fixture 104 is inserted into the tank 102. Generally, the divider 210 may be provided in the form of a wall 212, a bottom portion 214, and a top portion 216. In some instances, the bottom portion 214 and the top portion 216 may be provided as mirror images, although in other instances the bottom portion 214 and the top portion 216 need not be provided as mirror images. Both the bottom portion 214 and the top portion 216 may include a first panel 218 that is substantially perpendicular to the wall 212 and a second panel 220 that is substantially parallel to the wall 212. A first end 222 of the first panel 218 may abut the wall 212, while the second panel 220 may extend from a second end 224 of the first panel 218. Thus, the first and second panels 218, 220 of the bottom and top portions 214, 216 may, with the wall 212, define channels 226.

When the divider 210 is provided as part of the fixture 104, the plastic panels 180 may be at least partially inserted into the channels 226. More specifically, the plastic panels 180 may be positioned and received within the channels 226. In some instances, the plastic panels 180 may be completely or substantially retained within the divider 210.

The divider 210 may be composed of any durable material able to withstand prolonged exposures to temperatures of at least about 100° C. and/or a material that will not rust upon prolonged exposure to water. For example, the divider 210 may be primarily or substantially composed of stainless steel. In some instances, the divider 210 may include weep openings 228 provided in the form of apertures extending through the first panel 218 of the bottom portion 214. The shape and size of the weep openings 228 may vary. The first panel 218 of the bottom portion 214 may be provided with one, two, three, four, or more than four weep openings 228. In some instances, diameters of the weep openings 228 may be substantially identical. In other instances, the diameters of the weep openings 228 may be different. The weep openings 228 may be designed to allow for water to drain from the divider 210 (and thus the fixture 104) after the fixture 104 has been removed from the tank 102.

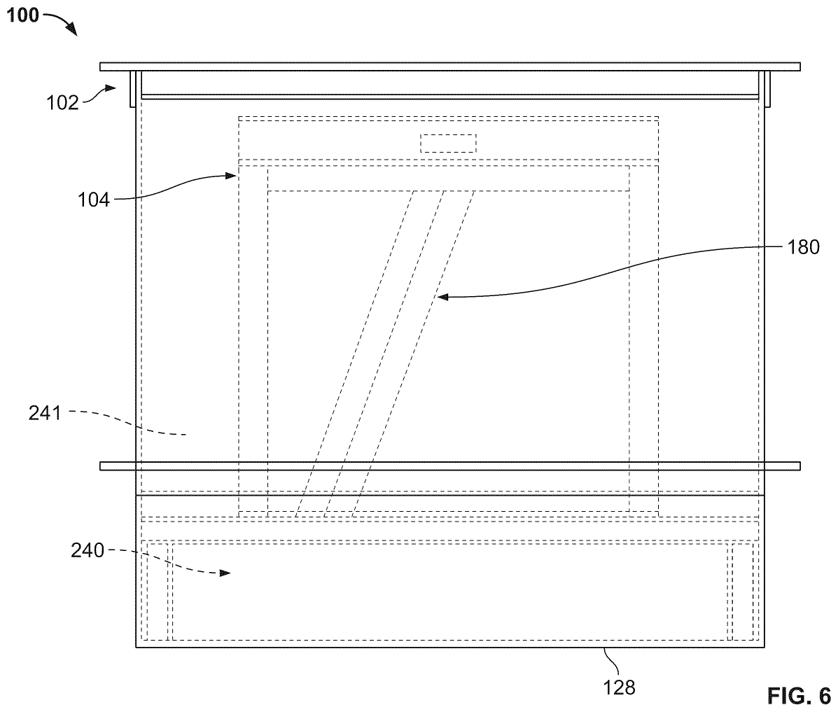

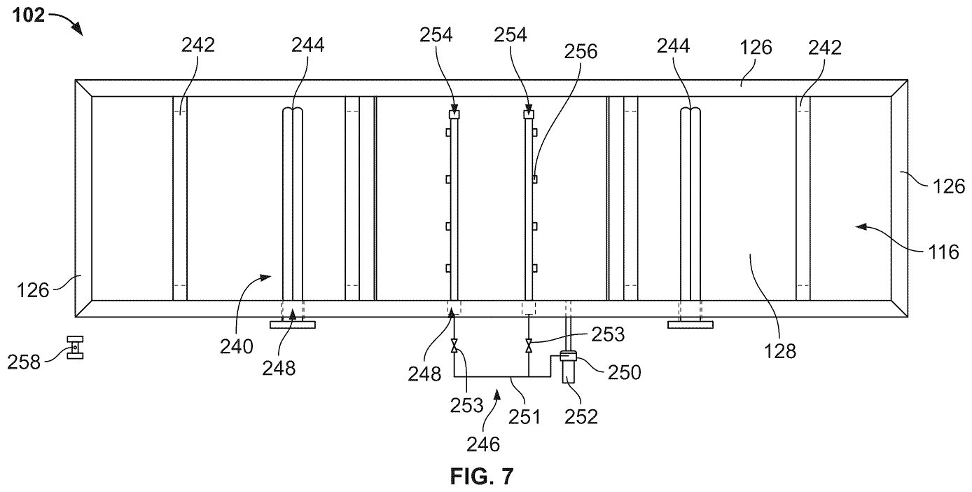

Referring now to FIG. 6, and as described with reference to FIG. 1, when loading with plastic panels 180, the fixture 104 may be at least partially, substantially, or fully submerged in the water retained in the tank 102 during the annealing process. To help facilitate the annealing process, the tank 102 may be provided with a heater 240. In certain instances, and as further described with reference to FIG. 7, the heater 240 may be provided in the form of one or more heating elements. The heater 240 may be provided in the form of any electric heater, gas heater, or other heater that is known in the art. The heater 240 may be designed to provide heat to the water in the tank 102 to increase the temperature of the water. In addition, the heater 240 may be designed to hold the temperature of the water substantially constant as the annealing process is being carried out and/or for a third predetermined time. In some instances, the third predetermined time is substantially equal to or greater than the amount of time the plastic panels 180 are submerged in the water of the tank 102. The heater 240 may be in communication with a control system (e.g., the control system 300 of FIG. 11). In such instances, the control system may direct operation of the heater 240. For example, the control system may activate the heater 240 for the third predetermined time and/or may determine the operating temperature of the heater 240. In certain cases, the control system may help direct operation of the heater 240 such that the water within the tank 102 maintains a consistent temperature and/or reaches a predetermined temperature (e.g., the first temperature).

Referring again to FIG. 6, water may be added to the tank 102 prior to or after the entrance of the fixture 104 into the tank 102. In some instances, the amount of water added to the tank 102 is sufficient to partially or completely submerge the fixture 104 in water after the fixture 104 enters the tank 102. In other instances, the amount of water added to the tank 102 is sufficient to partially or completely submerge the plastic panels 180 in water after the fixture 104 enters the tank 102. In certain instances, the amount of water added to the tank is such that the tank does not overflow after the fixture 104 enters the tank 102.

The heater 240 may be designed to impart the water in the tank 102 with the first temperature. For example, the heater 240 may be designed to impart the water in the tank 102 with a value of at least about 65° C. to no more than about 95° C., although the first temperature may also be somewhat less or somewhat greater than these values. As an additional example, the heater 240 may be designed to impart the water within the tank 102 with a value of at least about 70° C. to no more than about 90° C., or a value of at least about 80° C. to no more than about 85° C. As yet another example, the heater 240 may be designed to impart the water in the tank 102 with a value of at least about 66° C., or at least about 67° C., or at least about 68° C., or at least about 69° C., or at least about 71° C., or at least about 72° C., or at least about 73° C., or at least about 74° C., or at least about 75° C., or at least about 76° C., or at least about 77° C., or at least about 78° C., or at least about 79° C., or at least about 81° C., or at least about 82° C., or at least about 83° C., or at least about 84° C., or at least about 86° C., or at least about 87° C., or at least about 88° C., or at least about 89° C., or at least about 91° C., or at least about 92° C., or at least about 93° C., or at least about 94° C. In certain cases, the first temperature may be imparted with a value falling between any minimum or maximum value described above. In certain instances, the first temperature may be imparted with a range of values bounded by any minimum value and any maximum value as described above. In certain cases, the heater 240 may hold the water at a substantially constant temperature when the plastic panels 180 are submerged in the water of the tank 102. In other instances, the heater 240 may be designed to vary the temperature of the water when the plastic panels 180 are submerged in the tank 102. As further described with reference to FIG. 10, the behavior of the heater 240 may be adjusted by a control system at least partially, substantially, or completely based on measurements made by a temperature measuring device 241 designed to determine the temperature of the water disposed within the tank 102. It is to be understood that the temperature measuring device 241 may be any known device that is designed to determine or capable of determining a temperature of a liquid.

Referring now to FIG. 7, the tank 102 may further include one or more fixture support bars 242, one or more heating elements 244, and an eductor manifold 246. In some instances, the fixture support bars 242, the heating elements 244, and the eductor manifold 246 may be substantially co-planar and provided within the internal volume 116 of the tank 102. In other instances, the fixture support bars 242, the heating elements 244, and the eductor manifold 246 may be otherwise arranged within or coupled to the tank 102. For example, relative to the base 128, the fixture support bars 242 may be arranged above the heating elements 244 and the eductor manifolds 246. In some instances, the sidewalls 126 may include apertures 248 extending partially or completely through the sidewalls 126. The apertures 248 may be designed to receive various components of the tank 102 (e.g., the fixture support bars 242, the heating elements 244, the eductor manifolds 246) to help couple the components to the tank 102.

The fixture support bars 242 may be provided as an I-bar, an H-bar, a T-bar, or any other similar support element that is known in the art. Both ends of the fixture support bars 242 may be coupled to the sidewalls 126. If only a single fixture support bar 242 is provided, the fixture support bar 242 may be provided at or near a horizontally defined center of the base 128. If more than one fixture support bar 242 is provided, the fixture support bars 242 may be positioned such that the horizontally defined center of the base 128 is provided between at least two of the fixture support bars 242. In other instances, the fixture support bars 242 may be arranged in other manners than those described herein. In addition, the fixture 104 may abut the fixture support bars 242 when the fixture 104 is received in the tank 102 such that the fixture 104 does not contact the heating elements 244 or the eductor manifolds 246.

In some instances, the fixture support bars 242 may be composed of the same or substantially the same materials as the sidewalls 126. In other instances, the fixture support bars 242 may be comprised of a different material than the sidewalls 126. In certain instances, the fixture support bars 242 may be primarily or substantially composed of stainless steel.

The heating elements 244 may be coupled to the sidewalls 126. Alternatively, the heating elements 244 may be coupled to other surfaces of the tank 102, e.g., the base 128. The heating elements 244 may be positioned within the internal volume 116 of the tank 102 or otherwise positioned such that the heating elements 244 are in thermal communication with the internal volume 116 of the tank 102. As shown, the heating elements 244 may protrude outwardly and away from the sidewalls 126. In addition, the heating elements 244 may be received within the apertures 248 to help secure the heating elements 244 to the sidewalls 126. In some instances, the heating elements 244 may be provided in the form of a series of sheathed conductive metal coils (not illustrated) that are arranged coaxially. In certain instances, the metal coils may contain copper or an alloy thereof. In some instances, the heating elements 244 may be substantially flameproof. In certain instances, the heating elements 244 may be substantially waterproof.

In some instances, a single heating element 244 may be sufficient to heat the water in the tank 102 to the first temperature. In other instances, multiple heating elements 244 and/or other heating mechanisms may be used to heat the water disposed in the tank 102.

If only a single heating element 244 is provided, the heating element 244 may be provided at or near a horizontally defined center of the base 128, although the heating element 244 may be positioned elsewhere on or within the tank 102. If more than one heating element 244 is provided, the heating elements 244 may be positioned such that the horizontally defined center of the base 128 is provided between at least two of the heating elements 244, although the heating elements 244 may also be otherwise arranged.

The eductor manifold 246 is provided in the form of one or more eductors 250, at least one conduit 251, an eductor pump 252, and at least one valve 253. The eductor manifold 246 may be utilized to mix the water disposed in the tank 102 to help ensure that all of the water is at substantially the same temperature. The at least one conduit 251 may place the one or more eductors 250 into fluid communication with the eductor pump 252. The at least one valve 253 may be designed to selectively allow for fluid flow through particular eductors of the one or more eductors 250.

The one or more eductors 250 may be provided in the form of a substantially cylindrical, hollow body 254 coupled to or provided with spouts 256, although the one or more eductors 250 may also be provided in other shapes and forms. The one or more eductors 250 may be coupled to the sidewalls 126 and positioned within the internal volume 116 of the tank 102. The one or more eductors 250 protrude outwardly and away from the sidewalls 126 and may be received into the apertures 248. In some instances, two or more eductors 250 may be provided in the internal volume 116 of the tank 102. In other instances, only a single eductor 250 may be provided in the tank 102. The one or more eductors 250 may be positioned such that the horizontally defined center of the base 128 is provided between at least two eductors 250, although the one or more eductors 250 may also be positioned elsewhere in the tank 102.

The spouts 256 may be coupled to or otherwise provided on the body 254 of the eductor 250. In some instances, the spouts 256 may be arranged substantially collinearly on the body 254, although the spouts 256 may also be otherwise arranged on the body 254.

Each of the one or more eductors 250, and thus each body 254 and spout 256 of the one or more eductors 250, may be in fluid communication with the eductor pump 252. The eductor pump 252 may protrude from the base 128 and may be accessible from outside of the tank 102. In other instances, the eductor pump 252 may be provided within the internal volume 116 of the tank 102. In certain instances, the eductor pump 252 may be provided as any recirculating pump that is known in the art. The eductor pump 252 may cause water to flow through the one or more eductors 250 and thereby provide for water circulation throughout the tank 102.

The tank 102 may also be provided with an overflow pump 258. The overflow pump 258 may protrude outwardly from the base 128 and may be accessible from outside of the tank 102. In other instances, the overflow pump 258 may be provided in the internal volume of the tank. The overflow pump 258 may be in fluid communication with the internal volume 116 of the tank 102. In certain instances, the overflow pump 258 may help drain water from the internal volume 116 of the tank 102. For example, the overflow pump 258 may remove or eject water from the tank 102 when it is determined that the volume of water disposed in the tank 102 is too great and/or when the water is overflowing the tank 102. In some instances, more than one overflow pump 258 may be provided with the tank 102 to control a water level within the tank 102 with greater precision and/or speed.

In various instances, the one or more eductors 250, the eductor pump 252, and the overflow pump 258 may discard and replenish water at a periodic interval. For example, in some instances, the system discards and replenishes water at least every 20 minutes, although the system may discard and replenish water at an interval that is somewhat less than or even greater than these values. For example, the system may discard and replenish water at least about every 30 minutes, or least about every one hour, or at least about every two hours, at least about every 6 hours, or at least about every 12 hours, or at least about every 24 hours, or at least about every 48 hours, although the system may discard and replenish water at an interval that is somewhat less or somewhat greater than these values. As an additional example, the system discards and replenishes water at least every 30 minutes, or at least every one hour, or at least every two hours, or at least every 6 hours, or at least every 12 hours, or at least every 24 hours, or at least every 48 hours, although the system may discard and replenish water at an interval that is somewhat less or somewhat greater than these values. In some such instances, the water may be discarded through an additional discharge valve (not shown).

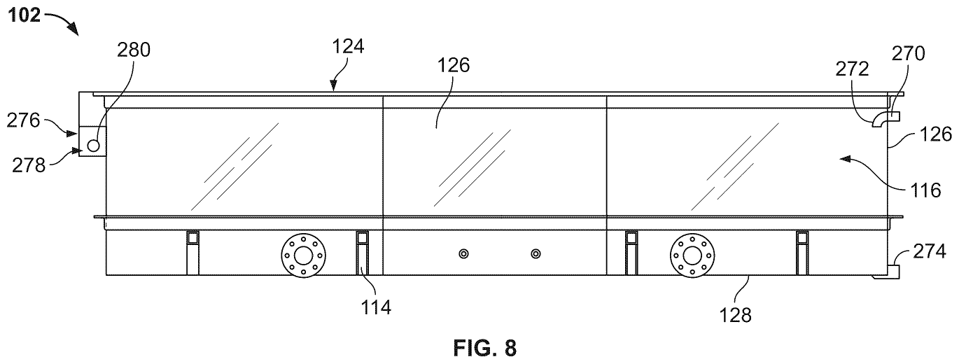

Referring now to FIG. 8, a faucet 270, a first drain 274, and a gutter 276 of the tank 102 are illustrated. Each of the faucet 270, the first drain 274, and the gutter 276 may be in fluid communication with the internal volume 116 of the tank 102. The faucet 270 may be in fluid communication with a water source (not illustrated) and may provide water from the water source to the internal volume 116 of the tank 102. Thus, the faucet 270 may be used to provide the tank 102 with water. The faucet 270 may be coupled to and extend through the sidewall 126 of the tank 102, as shown, or alternatively, the faucet 270 may be provided in the base 128 of the tank 102. In some instances, the tank 102 may not be provided with the faucet 270 and water may be otherwise introduced to the internal volume 116 of the tank 102 (e.g., via a hose). The faucet 270 may be positioned such that a mouth 272 of the faucet 270 ejects water downwardly and toward the base 128, although the faucet 270 may be otherwise arranged.

The first drain 274 may be used to remove water from the tank 102. The first drain 274 may be positioned on the sidewall 126 on which the faucet 270 is also positioned, although the drain may be positioned elsewhere in the tank 102 (e.g., the first drain 274 may be provided in the base 128). The first drain 274 may be provided as a conduit extending outwardly and away from the tank 102 and may be provided proximate or adjacent to the base 128 to help facilitate the removal of water from the internal volume 116. For example, the first drain 274 may extend through the sidewall 126 of the tank and abut the base 128.

In some instances, more than one faucet 270 and/or more than one drain 274 may be provided with the tank 102 to fill and/or empty the tank 102 with greater speed.

Referring now to FIGS. 8 and 9 together, the gutter 276 may be provided in the form of a trough 278 that is coupled to or provided with a second drain 280. The trough 278 of the gutter 276 may be provided as a substantially L-shaped body that includes a sloped surface 282 designed to facilitate the flow of water to the second drain 280 via the force of gravity. The trough 278 of the gutter 276 may also be provided in other shapes and forms (e.g., a substantially U-shaped body or a substantially cylindrical body). The second drain 280 may extend through the gutter 276 such that water may exit the gutter 276.

The gutter 276 may be coupled to at least one of the sidewalls 126 of the tank 102 proximate or adjacent to the top surface 124. The gutter 276 may collect water that overflows from the tank 102, e.g., when the fixture 104 (not illustrated) is moved into the tank 102. The second drain 280 may remove water from the trough 278 and provide the water to an external reservoir or to an external drainage system (not illustrated). In some instances, the gutter 276 may be coupled to each of the sidewalls 126 of the tank 102. In other instances, each sidewall 126 of the tank 102 may be provided with an individual gutter 276.

The gutter 276 may be composed of any durable material able to withstand prolonged exposures to temperatures of at least about 100° C. and/or a material that will not rust upon prolonged exposure to water. For example, the gutter 276 may be primarily or substantially composed of stainless steel.

Referring now to FIG. 10, a door 284 of the tank 102 is illustrated. The door 284 may be provided in the form of a body 286 and a hinge mechanism 288. The body 286 may be provided in the form of a thin rectangular prism, although the body 286 may also be provided in other shapes and forms. The body 286 of the door 284 may be substantially the same size as, or slightly larger than, the top surface 124 of the tank 102 such that the door 284 may partially, substantially, and/or completely isolate the internal volume 116 of the tank 102 from the outside environment when the door 284 is in a closed configuration. In comparison, when the door 284 is in the open configuration, the internal volume 116 of the tank 102 may be accessible. In some such instances, the fixture 104 (not shown) may be loaded into and removed from the tank 102.

In certain instances, the body 286 of the door 284 may include insulating material 130. The insulating material 130 may be provided within the body 286. In some instances, the insulating material 130 may be provided as an air gap. In other instances, the insulating material 130 may be provided as fiberglass, an insulating foam, or other similar materials. The insulating material 130 may be designed to help prevent heat loss from the tank 102 through the door 284 when the door 284 is in the closed position.

The hinge mechanism 288 of the door 284 may couple the door 284 to a sidewall 126 proximate or adjacent to the top surface 124. The hinge mechanism 288 may help facilitate the rotation of the door 284 about a hinge axis (not illustrated) so that the internal volume 116 of the tank 102 may be accessed more easily.

Turning now to FIG. 11, the annealing system 100 may include and be in communication with a control system 300. The control system 300 may include a controller 302 and a display 312. As shown in FIG. 11, the controller 302 may be electronically connected to and in electronic communication with the display 312. The display 312 may communicate information regarding the function and conditions of the annealing system 100 to an end user, such as the operator. The controller 302 also may be electronically connected to and may be in electronic communication with one or more of the annealing system 100 components, including, by way of example, the hoist system 106, the motor 156, the heater 240, the temperature measuring device 241, the eductor pump 252, the overflow pump 258, and/or the door 284.

The controller 302 may include electronic components such as one or more processors 304, a memory 306 (e.g., random access memory (RAM)), an input/output device 308, and a power supply 310 (e.g., battery or AC adapter plug). The controller 302 may be able to download, store, and/or execute software having computer-executable instructions. The software may include one or more modules. The one or more modules may include, for example, algorithms to monitor and/or store the measurements or other data received from one or more of the system components such as the sensors, valves, feeders, or pumps or may monitor and/or store real-time and historic flow patterns and usage data. The controller 302, via the one or more modules, may also perform determinations or other data analysis or modeling processes to determine various outcomes. The outcomes may include, for example, turning one or more of the system components of the water treatment system 172 on or off at certain times or intervals, placing one or more of the system components in standby mode, activating the hoist system 106, and/or actuating the hinge mechanism 288 to position the door 284 into the open configuration or the closed configuration.

In some instances, one or more measurements from the temperature measuring device 241 may be used as an input by the control system 300 in determining whether the heater 240 should be activated or whether the water disposed in the tank 102 is at a temperature such that the annealing process may be executed without the heater 240 being activated.

In certain instances, the control system 300 may prevent certain actions from being executed. For example, the control system 300 may prevent the actuation of the hoist system 106 when the door 284 is in the closed configuration. As an additional example, the control system may prevent loading and unloading of the fixture 104 from the tank 102 when the door 284 is in the closed configuration.

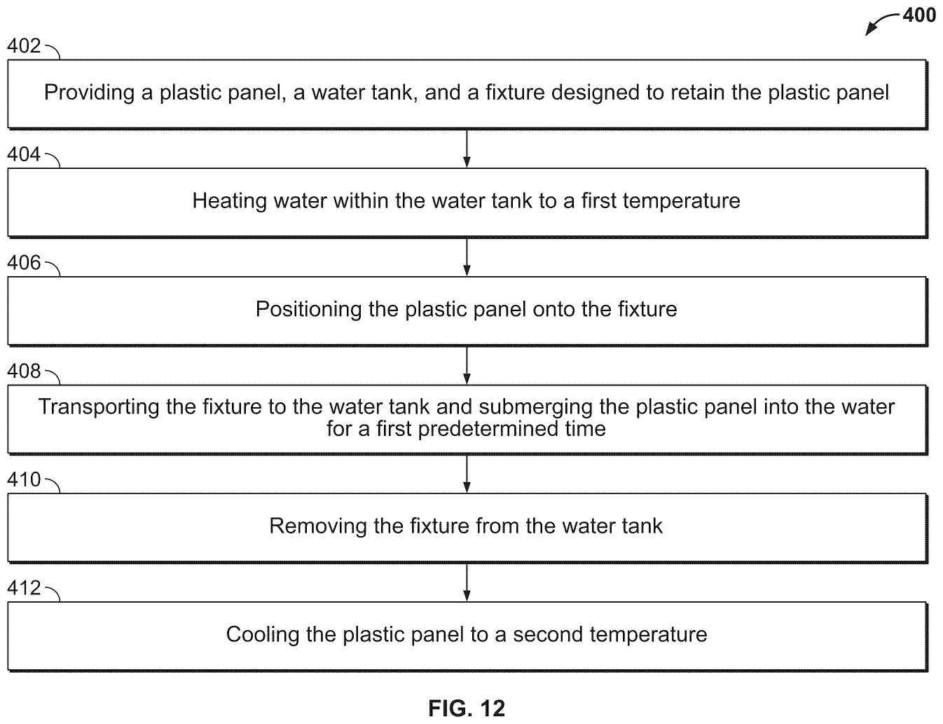

In various instances, the control system 300 may accept inputs from an operator for controlling the annealing system 100. For example, the operator may indicate via the display 312 that one or more materials, such as the plastic panels 180, are to be annealed. The control system 300 may in response initiate a preprogrammed procedure to facilitate the usage of the annealing system 100, such as by following the method 400 of FIG. 12. In some such instances, the control system 300 may thereby contain instructions for one or more of initiating heating of the tank 102, movement of the fixture 104 along the hoist system 106 into the tank 102, removing the fixture 104 from the tank 102 after the first predetermined time interval, and returning the fixture 104 to the home position for unloading of the plastic material after cooling for the second predetermined time interval. In other such instances, the entire annealing process executed by the annealing system 100 may be automated using the control system 300.

In some instances, the control system 300 may be physically coupled to the tank 102 or the surface 110. In other instances, the control system 300 may not be physically coupled to the tank 102 or the surface 110 and one may access one or more components of the annealing system 100 via a remote connection.

It is to be understood that any of the parameters associated with the annealing system 100 may be determined, measured, altered, and/or adjusted more than once. For example, a first measurement of a water temperature may be carried out at a first time period, followed by a second measurement carried out at a second time period, where the amount of time that elapses between the first time period and the second time period is determined by the predetermined time interval or another predetermined operational condition. In each instance, such measurements may be carried out by one or more measuring devices (e.g., the temperature measurement device) and then received and stored by a controller (e.g., the controller 302).

Referring now to FIG. 12, a method 400 for annealing one or more plastic structures is provided. The method 400 may include a step 402 of providing a plastic panel, a water tank, and a fixture designed to retain the plastic panel. In some instances, more than one plastic panel, such as 10 plastic panels, may be provided in the form of a stack. In some instances, the tank may be provided with a door that may be selectively opened and closed during the annealing process.

The method 400 may include a step 404 of heating water within the water tank to a first temperature. In various instances, the first temperature may be imparted with a value of at least about 65° C. to no more than about 95° C., although the first temperature may also be somewhat less or somewhat greater than these values. In certain cases, the water may be held at a substantially constant temperature when the plastic panels are submerged in the water of the tank 102. In other instances, the temperature of the water may vary when the plastic panels are submerged in the tank.

The method 400 may include a step 406 of positioning the plastic panel onto or into the fixture. In some instances, the fixture may first be placed upon risers such that the plastic panel may be loaded at an appropriate height.

The method 400 may include a step 408 of transporting the fixture to the water tank and submerging the plastic panel in the water for a first predetermined time. In various instances of the method 400, a hoist system may be utilized to transport the fixture. The hoist system may lift the fixture from an initial position, transport the fixture along a rail system until the fixture is above the tank, and then lower the fixture to deposit the fixture within the tank.

The method 400 may include a step 410 of removing the fixture from the water tank. In some instances, the fixture may be removed from the water tank upon a notification to an operator, for example, by using an andon light. In other instances, the method 400 may include a step of providing a notification. In such instances, the notification may be provided in the form of a visual indicator (e.g., an andon light), an audio indicator (e.g., a horn), and/or a notification sent to a user device (e.g., a text notification provided to a cell phone).

The method 400 may include a step 412 of cooling the plastic panel to a second temperature. In some instances, prior to cooling, the method 400 may include imparting the plastic panel with relief cuts and/or bends in order to prevent tear and deformation of the panel when cutting. In various instances, the second temperature may be imparted with a value of at least about 0° C. to no more than about 30° C. In certain cases, the ambient temperature may be held at a substantially constant value when the plastic panels are being cooled. In other instances, the ambient temperature may vary as the plastic panels are being cooled.

The method 400 may include additional steps or fewer steps than those described herein. The method 400 may also include any or all of the components of the annealing system 100 as described with reference to FIGS. 1-10. In some instances, one or more of steps 404, 408, 410, and 412 may be automated and controlled by a controller operatively coupled to one or more of the components of the annealing system. In some such instances, at least steps 402 and 406 may be performed manually by an operator. It is to be understood that the steps of the method 400 may be performed in any order, that the steps of the method 400 may be repeated, and that various steps of the method 400 may be omitted.

Advantageously, the annealing systems and methods described herein may provide a faster annealing process that produces more consistent results than other systems and methods. Without being bound to a particular theory, the annealing systems and methods described herein are faster and produce more consistent results than prior art annealing systems due to the greater thermal mass and thermal conductivity of water compared to the common method of heating the material to be annealed using heated air or another heated gas mixture. The higher thermal mass of the water helps hold the temperature of the material to be annealed more constant once it reaches the same temperature as the water, and the higher thermal conductivity of water helps transfer heat to the material to be annealed more quickly.

One of the more difficult aspects of machining plastic parts is keeping the machined plastic parts flat, especially when the final geometry is somewhat or particularly asymmetric. During machining, if more material is removed from one side of the material's centerline than the other, the material will “dish up” or warp towards the side that has had more material removed. The amount of residual stress locked into the material determines how much the material will warp once the outer material is removed. Excessive heat build-up during machining can also contribute to such material movement. Since the systems and methods described herein may produce an annealed material that is imparted with less internal stress than non-annealed materials, the materials produced by the annealing systems and methods described herein may be less prone to warping as compared to materials that have not been annealed or have been annealed using alternative methods.

It will be appreciated by those skilled in the art that while the disclosure has been described above in connection with particular instances and examples, the disclosure is not necessarily so limited, and that numerous other instances, examples, uses, modifications and departures from the instances, examples and uses are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

1. An annealing system, comprising:
a fixture designed to receive a plastic material, the fixture comprising a frame having an open end;
a tank provided in the form of a base coupled to sidewalls extending upwardly and away from the base, wherein the tank is designed to receive the fixture and retain water;
a heating element coupled to and disposed within the tank, wherein the heating element is designed to impart the water disposed within the tank with a first temperature; and
a hoist system designed to transport the fixture into and out of the tank,
wherein the annealing system is designed to anneal the plastic material.

2. The annealing system of claim 1, wherein the fixture further comprises an end stop positioned on the frame opposite the open end.

3. The annealing system of claim 1 further comprising a controller designed to operate the heating element and position the fixture in the tank for a first predetermined time, wherein the first temperature is at least about 65° C. and no more than about 95° C., and the first predetermined time is at least about 15 minutes.

4. The annealing system of claim 3, wherein the first temperature is at least about 75° C. and no more than about 95° C.

5. The annealing system of claim 1 further comprising a water treatment system fluidly coupled to the tank.

6. The annealing system of claim 5, wherein the water treatment system is designed to remove one or more impurities from the water within the tank, and the one or more impurities are selected from the group consisting of dissolved ions, minerals, and particulates.

7. The annealing system of claim 1, wherein the plastic material is provided in the form of panels or sheets.

8. The annealing system of claim 1, wherein the tank includes a door coupled to the tank by a hinge mechanism.

9. The annealing system of claim 1, wherein the fixture further comprises a divider designed to prevent the plastic material from floating out of the fixture.

10. An annealing system for plastic materials, comprising:
a fixture provided in the form of a frame, the frame designed to support a plastic material at an angle relative to a floor of the fixture;
a water tank including a heating element;
a hoist system; and
a control system including a controller, wherein the fixture, the water tank, and the hoist system are all in electrical communication with the control system,
wherein the controller is designed to:
activate the heating element to heat water provided in the water tank to a first predetermined temperature, and
direct the hoist system to submerge the plastic material in the water for a first predetermined time.

11. The annealing system of claim 10, wherein the hoist system is provided with a motor in electrical communication with the controller.

12. The annealing system of claim 10, wherein the first predetermined time is at least about 30 minutes and the first predetermined temperature is at least about 75° C.

13. The annealing system of claim 10, wherein the control system further comprises a display, a memory, and a power supply.

14. A method for annealing plastic materials comprising:
providing a water tank and a fixture loaded with a plastic material;
heating water within the water tank to a first temperature;
transporting the fixture to the water tank and immersing the plastic material in the water for a first predetermined time;
removing the fixture from the water tank; and
cooling the plastic material to a second temperature.

15. The method of claim 14, wherein the fixture is provided in the form of a floor, joists, and support columns arranged substantially in a shape of a rectangular prism.

16. The method of claim 14 further comprising adding one or more relief cuts to the plastic material.

17. The method of claim 16, wherein the one or more relief cuts are made to the plastic material prior to cooling the plastic material to the second temperature.

18. The method of claim 14 further comprising positioning the plastic material within a divider prior to positioning the plastic material in the fixture.

19. The method of claim 14 further comprising positioning the plastic material at an acute angle relative to a floor of the fixture.

20. The method of claim 19, wherein the acute angle is imparted with a value of at least about 65 degrees.
